(19) United States
(12) Patent Application Publication
(10) Pub. No.: US 2020/0026786 A1
(43) Pub. Date: Jan. 23, 2020

(54) MANAGEMENT AND SYNCHRONIZATION OF BATCH WORKLOADS WITH ACTIVE/ACTIVE SITES USING PROXY REPLICATION ENGINES

(71) Applicant: International Business Machines Corporation, Armonk, NY (US)

(72) Inventors: Paul M. Cadarette, Hernet, CA (US); David B. Petersen, Great Falls, VA (US); Serge Bourbonnais, Palo Alto, CA (US); Michael G. Fitzpatrick, Raleigh, NC (US); Pamela L. McLean, Raleigh, NC (US); John G. Thompson, Tucson, AZ (US); Gregory W. Vance, Morgan Hill, CA (US); David A. Clitherow, Bracknell (GB)

(21) Appl. No.: 16/038,682

(22) Filed: Jul. 18, 2018

(51) Int. Cl. G06F 17/30

(52) U.S. Cl. CPC G06F 17/30377; G06F 17/30002; G06F 17/30371; G06F 17/30575

(57) ABSTRACT

A method for resynchronizing at least one batch job is provided. The method may include detecting a type of region switch request. The method may further include stopping execution workloads on a primary system based on the switch request. The method may further include suspending software and hardware data replication from the primary system to the secondary system. The method may further utilizing proxy replication engine to determine a point-in-time (PIT) at which the execution is stopped and the suspension. The method may also include switching the replication of the software and hardware data to occur the secondary system to the primary system. The method may further include synchronizing the software and hardware data up to the determined point-in-time (PIT). The method may also include activating the execution of the plurality of workloads on the secondary system based on the determined point-in-time (PIT), switching, and synchronizing.

### BACKGROUND

The present invention relates generally to the field of computing, and more specifically, to data processing and management.

Generally, Active/Active Sites is a network of independent computer processing systems where each system has access to a replication database in order to give each system access and usage of shared workloads. In an Active/Active Sites system environment all requests are load-balanced across all available processing systems. Where a failure occurs on a system, another system in the network takes its place. Active/Active Sites (i.e., A/A Sites) are designed to provide continuous availability, disaster recovery, and cross-region workload balancing for defined Active/Active Sites workloads associated with the Active/Active Sites system environment. Active/Active Sites workloads are currently limited to online transaction processing (OLTP) applications and data objects associated with the OLTP applications. Specifically, online transaction processing (OLTP) workloads are comprised of short transactions that perform business operations (such as changing/updating database records) across one or more database management systems (DBMS) on an Active/Active Sites system environment. Batch workloads are long running processes comprised of DBMS transactions that may modify large amounts of data and often uses storage outside of the DBMS (e.g., files) to record the progress of the process for recovery purposes.

Specifically, batch workloads or batch processing is an execution of a series of programs (“jobs”) on a computer without manual intervention. The input data to set up the batch workloads/jobs are preselected through scripts, command-line parameters, or job control language. More specifically, in batch processing, a program may utilize a set of data files as input, process the data, and may produce a set of intermediate and output data files to help facilitate the execution of the batch workloads. This operating environment is termed as “batch processing” since the input data is collected into batches of files and are processed in batches by the program.

### SUMMARY

A method for managing at least one batch job comprising a plurality of workloads executing on both a primary system and on a secondary system, and for synchronizing both software data and hardware data stored on the primary system with the secondary system using at least one proxy replication engine is provided. The method may include detecting a type of region switch request. The method may further include, in response to the detected type of region switch request, stopping the execution of the plurality of workloads on the primary system. The method may further include, in response to stopping the execution of the plurality of workloads, suspending a replication of the software data stored on the primary system with the software data stored on the secondary system, and suspending a replication of the hardware data stored on the primary system with the hardware data stored on the secondary system. The method may further include utilizing the at least one proxy replication engine to determine a point-in-time (PIT) at which the execution of the plurality of workloads on the primary system is stopped, at which the replication of the software data is suspended, and at which the replication of the hardware data is suspended, wherein utilizing the at least one proxy replication engine comprises using the at least one proxy replication engine to read from at least one secondary log the hardware data comprising a plurality of batch components associated with the plurality of workloads and the point-in-time (PIT).

The method may also include switching the replication of the software data that occurs from the primary system to the secondary system to occur from the secondary system to the primary system. The method may further include switching the replication of the hardware data that occurs from the primary system to the secondary system to occur from the secondary system to the primary system. The method may also include synchronizing the software data and the hardware data for the plurality of workloads up to the determined point-in-time (PIT) and based on the point-in-time (PIT) associated with the plurality of batch components. The method may further include activating the execution of the plurality of workloads on the secondary system from the determined point-in-time (PIT), and based on the switching of the replication of both the hardware data and the software data, and based on the synchronization of the software data and the hardware data up to the determined point-in-time (PIT) associated with the at least one proxy engine and the plurality of batch components.

A computer system for managing at least one batch job comprising a plurality of workloads executing on both a primary system and on a secondary system, and for synchronizing both software data and hardware data stored on the primary system with the secondary system using at least one proxy replication engine is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include detecting a type of region switch request. The method may further include, in response to the detected type of region switch request, stopping the execution of the plurality of workloads on the primary system. The method may further include, in response to stopping the execution of the plurality of workloads, suspending a replication of the software data stored on the primary system with the software data stored on the secondary system, and suspending a replication of the hardware data stored on the primary system with the hardware data stored on the secondary system. The method may further include utilizing the at least one proxy replication engine to determine a point-in-time (PIT) at which the execution of the plurality of workloads on the primary system is stopped, at which the replication of the software data is suspended, and at which the replication of the hardware data is suspended, wherein utilizing the at least one proxy replication engine comprises using the at least one proxy replication engine to read from at least one secondary log the hardware data comprising a plurality of batch components associated with the plurality of workloads and the point-in-time (PIT).

The method may also include switching the replication of the software data that occurs from the primary system to the secondary system to occur from the secondary system to the primary system. The method may further include switching the replication of the hardware data that occurs from the primary system to the secondary system to occur from the secondary system to the primary system. The method may also include synchronizing the software data and the hardware data for the plurality of workloads up to the determined point-in-time (PIT) and based on the point-in-time (PIT) associated with the plurality of batch components. The method may further include activating the execution of the plurality of workloads on the secondary system from the determined point-in-time (PIT), and based on the switching of the replication of both the hardware data and the software data, and based on the synchronization of the software data and the hardware data up to the determined point-in-time (PIT) associated with the at least one proxy engine and the plurality of batch components.

A computer program product for managing at least one batch job comprising a plurality of workloads executing on both a primary system and on a secondary system, and for synchronizing both software data and hardware data stored on the primary system with the secondary system using at least one proxy replication engine is provided. The computer program product may include one or more computer-readable storage devices and program instructions stored on at least one of the one or more tangible storage devices, the program instructions executable by a processor. The computer program product may include program instructions to detect a type of region switch request. The computer program product may further include program instructions to, in response to the detected type of region switch request, stop the execution of the plurality of workloads on the primary system. The computer program product may also include program instructions to, in response to stopping the execution of the plurality of workloads, suspending a replication of the software data stored on the primary system with the software data stored on the secondary system, and suspending a replication of the hardware data stored on the primary system with the hardware data stored on the secondary system. The computer program product may further include program instructions to utilize the at least one proxy replication engine to determine a point-in-time (PIT) at which the execution of the plurality of workloads on the primary system is stopped, at which the replication of the software data is suspended, and at which the replication of the hardware data is suspended, wherein utilizing the at least one proxy replication engine comprises using the at least one proxy replication engine to read from at least one secondary log the hardware data comprising a plurality of batch components associated with the plurality of workloads and the point-in-time (PIT).

The computer program product may also include program instructions to switch the replication of the software data that occurs from the primary system to the secondary system to occur from the secondary system to the primary system. The computer program product may further include program instructions to switch the replication of the hardware data that occurs from the primary system to the secondary system to occur from the secondary system to the primary system. The computer program product may also include program instructions to synchronize the software data and the hardware data for the plurality of workloads up to the determined point-in-time (PIT) and based on the point-in-time (PIT) associated with the plurality of batch components. The computer program product may further include program instructions to activate the execution of the plurality of workloads on the secondary system from the determined point-in-time (PIT), and based on the switching of the replication of both the hardware data and the software data, and based on the synchronization of the software data and the hardware data up to the determined point-in-time (PIT) associated with the at least one proxy engine and the plurality of batch components.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is a block diagram illustrating the hardware that may be used in a networked computer environment with an exemplary failover model to manage and synchronize batch components with Active/Active Sites workloads according to one embodiment;

FIG. 3 is an operational flowchart illustrating the steps carried out by a program for utilizing proxy replication engines to synchronize the restart of A/A Sites managed workloads with batch components following a planned or unplanned region switch operation for a computer system according to one embodiment;

FIG. 4 is a block diagram of the system architecture of the program for utilizing proxy replication engines to synchronize the restart of A/A Sites managed workloads with batch components according to one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate generally to the field of computing, and more particularly, to data processing and management. The following described exemplary embodiments provide a system, method and program product for resynchronizing at least one batch job comprising a plurality of workloads executing on both a primary system and on a secondary system by using at least one proxy replication engine. Specifically, proxy replication engines may be utilized to synchronize at a determined point-in-time (PIT) the restart of A/A Sites managed online transaction processing (OLTP) workloads and batch components that are associated with a batch job according to one embodiment. Furthermore, the present embodiment has the capacity to improve the technical field associated with restarting a batch job based on a planned or unplanned region switch by using proxy replication engines to read from secondary logs and synchronize the software data and hardware data associated with the batch job to thereby eliminate time conflicts that arises during the batch job restart. More specifically, the system, method and program product may manage and synchronize batch components and workloads associated with batch jobs while maintaining a point-in-time (PIT) consistency between the online transaction processing (OLTP) workloads and the batch components.

As previously described with respect to data processing and management, online transaction processing (OLTP) may include a transactional system that processes workloads comprising short transactions. For example, the OLTP workloads may include transactions that perform business operations across one or more database management systems (DBMSs). Batch processing may include long running batch jobs comprised of: 1) multiple OLTP workloads that modify large amounts of data objects, and 2) batch components, such as sets of intermediate data files as well as job scheduler states and plan files, to help facilitate the execution of the OLTP workloads. The batch components may be received as input (for example, from a user/administrator or based on computer machine-learning techniques), and be utilized to describe how, when, what order, and the state of the batch jobs that include the OLTP workloads.

Batch processing may be performed on one or more active sites in an Active/Active Sites system environment. Specifically, a standby site may be used in case of a system disaster to the one or more active sites and/or to share the processing of the batch jobs. More specifically, in an Active/Active continuous availability topology, there may be two or more sites where any given workload associated with a batch job can execute at a prescribed time or can be used to restart a batch job in case of a disaster. As such, Active/Active Sites (aka A/A Sites) are designed to provide continuous availability, disaster recovery, and cross-site workload balancing for defined Active/Active workloads. However, Active/Active workloads, such as OLTP workloads, are limited to workloads that can only be software replicated by capturing log records and replaying transactions. But batch jobs, particularly in a mainframe environment, may use some operations that are not software logged. These operations that are not software logged may include the batch components associated with the batch jobs such as the aforementioned intermediate data files and the job scheduler states and plan files. Such batch components must be considered in all planned and unplanned Active/Active workload and/or site switches.

While Active/Active Sites can currently provide software replication for the data objects targeted by the OLTP transactions associated with the batch jobs, support for the synchronization of batch components, such as intermediate data files as well as job scheduler states and plan files, that are critical for the successful re-processing of interrupted batch jobs during site switches, are only supported today using hardware. Specifically, the synchronization of batch components may include concurrent disk recovery (DR) sites that are synchronized using disk replication, and a procedural methodology to re-sync the software replicated OLTP workloads with the disk recovered data at the successor site.

However, in the current procedural methodology, since software replication and hardware replication are managed separately, the OLTP workload data associated with the Active/Active Sites may be inconsistent in time with the batch components once the resynchronization process is completed at a successor site. Specifically, the procedural methodology to re-sync an online transaction processing (OLTP) software replication with a hardware recovery disk replication site is hampered by data conflicts that arise during the resynchronization process between the disk replication of intermediate files and job scheduler states/plan files with the software replication of the OLTP workloads. These conflicts arise due to the natural point-in-time (PIT) inconsistency between batch components associated with disk replication, which manages PIT consistency at a track (or step-by-step) boundary, and the OLTP workloads associated with software replication, which manages point-in-time (PIT) consistency at a transactional boundary. Thus, the point-in-time (PIT) where the software replication and the disk replication of a batch job are resynchronized at the successor site may be inconsistent.

Therefore, the resynchronization may cause a discrepancy between the OLTP workload transaction files and the batch components (i.e. the intermediate data files, and the job scheduler states and plan files) during a batch job start or restart on the successor site. As such, it may be advantageous, among other things, to provide a system, method and computer program product for managing and synchronizing batch components and OLTP workloads associated with batch jobs while maintaining point-in-time (PIT) consistency between the OLTP workloads and the batch components. Specifically, in response to a planned, or unplanned, interruption of a batch job, the system, method, and program product may eliminate data and time inconsistencies between batch components and the OLTP workloads associated with the batch job start/restart by utilizing a proxy server to determine the point-in-time (PIT) of the interruption for the OLTP workload data and batch component data. More specifically, the system, method and computer program product may determine the point-in-time (PIT) of the interruption for the OLTP workload data and batch component data by reading from secondary replication logs, and use the proxy server to re-synchronize the batch components and the OLTP workloads up to the point-in-time of the planned, or unplanned, interruption.

According to at least one implementation of the present embodiment, a planned or unplanned system region switch may be detected between a primary system and a secondary system. Then, in response to the detection of the system region switch, the execution of a plurality of workloads on the primary system may be stopped. Next, in response to the detection of the system region switch, replication of the software data stored on the primary system with the software data stored on the secondary system may be suspended. Also, in response to the detection of the system region switch, replication of the hardware data stored on the primary system with the hardware data stored on the secondary system may be suspended. Then, one or more proxy replication engines may be utilized to determine/capture the point-in-time (PIT) at which the A/A Sites workloads are stopped, at which replication of the non-A/A Sites workload data (i.e. hardware-replicated batch components) that is associated with the A/A Sites workloads is suspended, and at which the A/A Sites workload data. Next, the replication of the software data that occurs from the primary system to the secondary system may be switched to occur from the secondary system to the primary system. Then, the replication of the hardware data that occurs from the primary system to the secondary system may be switched to occur from the secondary system to the primary system. Next, the one or more proxy replication engines may be utilized to restart the A/A Sites workloads by synchronizing the software data with the hardware data following the determined type of region switch. Then, the batch job resynchronization program 108A may activate execution of the A/A Sites workloads on the secondary system based the determined point-in-time (PIT).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for resynchronizing at least one batch job comprising a plurality of workloads executing on both a primary system and on a secondary system by using at least one proxy replication engine.

Specifically, according to at least one implementation of the present embodiment, a planned or unplanned system region switch may be detected between a primary system and a secondary system. Then, in response to the detection of the system region switch, the execution of a plurality of workloads on the primary system may be stopped. Next, in response to the detection of the system region switch, replication of the software data stored on the primary system with the software data stored on the secondary system may be suspended. Also, in response to the detection of the system region switch, replication of the hardware data stored on the primary system with the hardware data stored on the secondary system may be suspended. Then, one or more proxy replication engines may be utilized to determine/capture the point-in-time (PIT) at which the A/A Sites workloads are stopped, the at which replication of the non-A/A Sites workload data (i.e. hardware-replicated batch components) that is associated with the A/A Sites workloads is suspended, and at which the A/A Sites workload data (i.e. software data including OLTP workload data) that is associated with the A/A Sites workloads is suspended based on the detected type of region switch. Next, the replication of the software data that occurs from the primary system to the secondary system may be switched to occur from the secondary system to the primary system. Then, the replication of the hardware data that occurs from the primary system to the secondary system may be switched to occur from the secondary system to the primary system. Next, the one or more proxy replication engines may be utilized to restart the A/A Sites workloads by synchronizing the software data with the hardware data following the determined type of region switch. Then, the batch job resynchronization program 108A may activate execution of the A/A Sites workloads on the secondary system based the determined point-in-time (PIT).

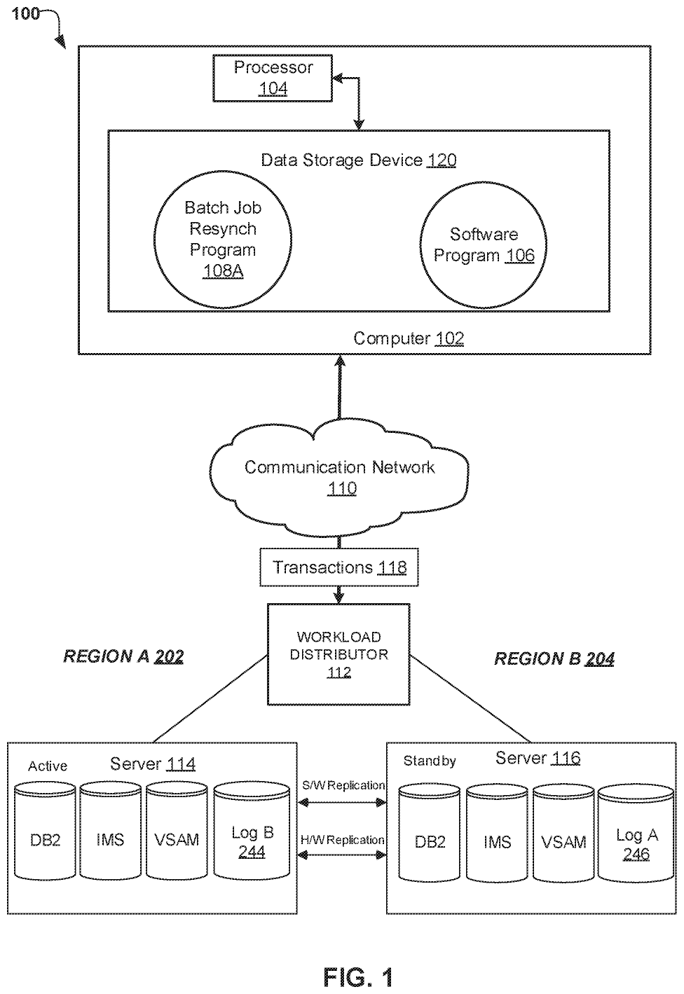

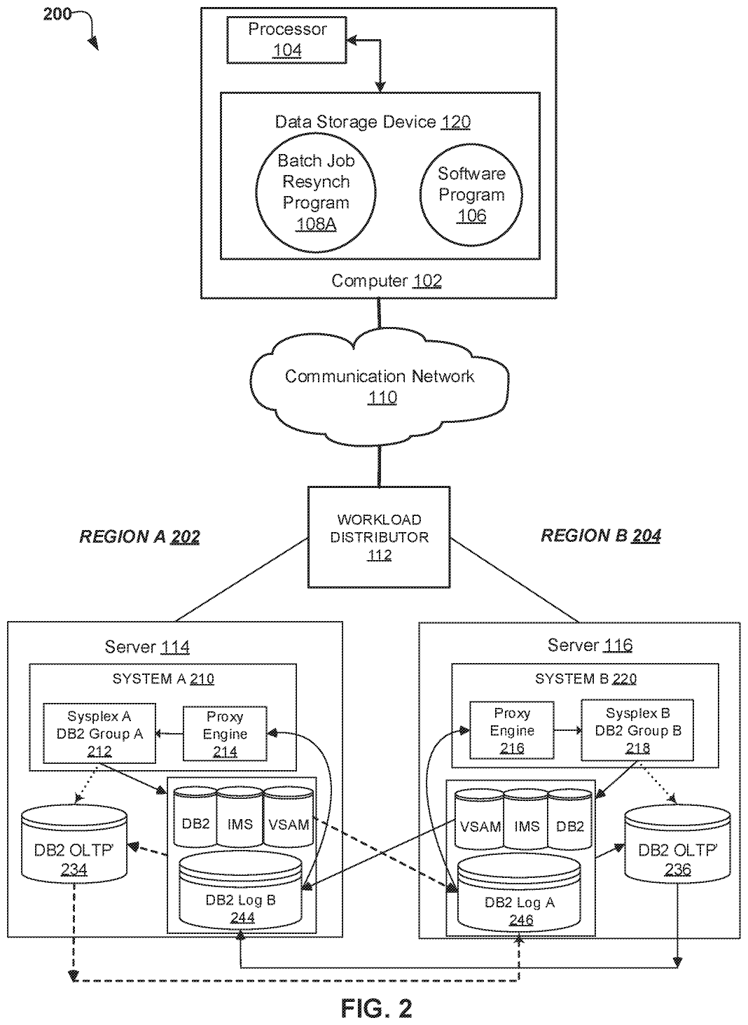

Referring to FIG. 1, the hardware components that may be used in a networked computer environment 100 with a failover model to manage and synchronize Active/Active Sites batch jobs is depicted. Active/Active Sites (A/A Sites) are designed to provide continuous availability, disaster recovery, and cross-region workload balancing. According to at least one embodiment of the present invention, the current environment may utilize software data replication (i.e., software replication) and hardware data replication (i.e., disk replication) between two or more regions, such as between Region A 202 and Region B 204, whereby software data and hardware data may be synchronized based on execution of a batch job. Furthermore, and as will be further discussed in FIG. 2, in case of a region switch, one or more proxy replication engines (not shown) may be used to read from replication logs located on secondary volumes, such as Log B 244 and Log A 246, to re-synchronize the software data with the hardware data to a consistent point-in-time (PIT) so as to avoid conflicts associated with a restart of the batch job.

In FIG. 1, the networked computer environment 100 may include a computer 102 with a processor 104 and a data storage device 120 that are enabled to run a batch job resynchronization program 108A and a software program 106, and may also include a microphone (not shown). The software program 106 may be an application program such as an internet browser. The batch job resynchronization program 108A may communicate with the software program 106. The networked computer environment 100 may also include servers 114, 116 that are enabled to run the batch job resynchronization program 108A via the communication network 110 and/or the batch job resynchronization program 108A may reside on the servers 114, 116. The networked computer environment 100 may include a plurality of computers 102 and servers 114, 116, despite what is shown for illustrative brevity in FIG. 1.

As depicted in FIG. 1, A/A Sites (including the active/standby configuration between the active server 114 and the standby server 116) may support processing of A/A Site batch jobs. Specifically, for example, an A/A site continuous availability topology may include the Region A 202 with an active site residing on a server 114, and a Region B 204 with a standby site residing on server 116. Each server may house one or more databases to support the processing and storing of batch job/workload data. For example, DB2 is a relational model database server developed by IBM; Information Management System (IMS™) is a transaction and hierarchical database manager for critical online applications developed by IBM; and virtual storage access method (VSAM) is an IBM disk file storage access method. A/A Sites workloads are workloads that support OLTP using database management systems (DBMSs) such as the DB2, the IMS, and/or the VSAM, which also have the ability to perform planned and unplanned region switches in seconds. In Active/Active Sites, the DBMSs are synchronized using software replication. The A/A sites may further include the previously mentioned secondary log volumes 244, 246, which may include a computer system, server, or application that is attached to, located on, or connected with the servers 114, 116, respectively. The secondary log volumes 244, 246 may be used to log batch job/workload data associated with a batch job, such as batch component data, that may be executed on Region A 202 and/or Region B 204. For example, secondary Log A 246 may be located and/or stored on Region B 204, and may log batch job data executing on Region A 202. Furthermore, secondary Log B 244 may be located and/or stored on Region A 202, and may log batch job data executing on Region B 204. As such, in case of a system failure to either Region A 202 or Region B 204, a system region switch, and/or system batch job restart, recovery of the batch job/workload data is possible between the two regions. As will be discussed in FIG. 2, proxy replication engines may be used between the servers 114, 116 to capture content associated with the DBMSs to facilitate point-in-time (PIT) synchronization of the software data associated with the OLTP and the hardware data associated with batch components in case of planned and unplanned region switches.

As previously described, the networked computer environment 100 may include server computers 114 and 116 that are enabled to run DB2 replication, IMS replication, and/or VSAM replication. The client computer 102 may issue transactions 118 via a communication network 110 to a workload distributor 112. The workload distributor 112 is software and/or hardware that balances the workload distribution for each transaction, and may determine how the workload should be distributed to the regions. As such, the workload distributor 112 may interact with servers 114 and 116. Server 114 and server 116 may be separated by unlimited distances, running the same applications and having the same data. As such, servers 114 and 116 will replicate with each other to ensure cross-region (or cross-site) workload balancing and continuous availability and disaster recovery.

The communication network may include various types of communication networks, such as a wide area network (WAN), local area network (LAN), a telecommunication network, a wireless network, a public switched network and/or a satellite network.

The client computer 102 may communicate with workload distributor 112 via the communications network 110. The workload distributor 112 may execute computer instructions for continuous availability across multiple regions or regions at unlimited distances. The one or more workload distributors 112 may operate in any type of environment that is capable of executing a software application. One or more workload distributors 112 may include a high-speed computer processing device, such as a mainframe computer or router, to manage the volume of operations governed by an entity for which a continuous availability across multiple region or sites at unlimited distances process is executing. The one or more workload distributors 112 may be part of an enterprise (e.g., a commercial business) that implements the continuous availability across multiple regions or sites at unlimited distances.

As previously described, the system depicted in FIG. 1 includes one or more regions such as Region A 202 where server 114 resides and Region B where server 116 resides. Each of the regions include one or more systems executing one or more workloads. The workloads include transaction processing applications, database applications, queue management operations. As previously described, each of the regions includes one or more hardware devices (such as servers 114 and 116), and/or software (such as workload distributor 112) for managing and distributing network traffic among the one or more systems. The system depicted in FIG. 1 may additionally include a software data replication module (not shown). The software data replication module replicates data (i.e., software replication) for each of the workloads between Region A 202 and Region B 204.

FIG. 2 illustrates the hardware that may be used in a networked computer environment with an exemplary failover model to manage and synchronize batch non-A/A Sites workload data (i.e. batch components) with A/A Sites OLTP workload data according to one embodiment. The present invention uses proxy replication engines 214 and 216, that read from the replication logs on the secondary volumes (Log A 246 and Log B 244), to determine a point-in-time (PIT) that is consistent between 1) the executed OLTP workloads and 2) the batch components that reside on the secondary volumes 244, 246, that are required for a batch job restart so as to avoid data conflicts in the batch job. As previously stated, at least one embodiment of the present invention utilizes the replication of software data (i.e., Active/Active Sites workload data) as previously described with respect to FIG. 1 in addition to disk replication of hardware data (i.e., batch non-Active/Active Sites component data). As depicted in FIG. 2, customers may have the ability to deploy both A/A Sites workloads and non-A/A Sites workloads in an A/A Sites two system (i.e., System A 210 and System B 220) configuration. The A/A Site's disk integration support may optionally provide the capability for non-A/A Sites workloads to be managed by A/A Sites and switched between multiple regions. For example, a first site or region (i.e., Region A 202) and a second site or region (i.e., Region B 204) may be used to restore A/A Sites continuous availability for A/A Sites workloads after a planned or unplanned region switch from Region A 202 to Region B 204, or from Region B 204 to Region A 202.

Specifically, in FIG. 2, a primary system, such as System A 210 may reside in Region A 202 and on server 114. A secondary system, such as System B 220, may reside in Region B 204 and on server 116. Hardware data replication (i.e., disk replication) and software data replication (i.e., software replication) of A/A Sites may be deployed across Region A 202 and Region B 204. Additionally, embodiments of the present invention may be implemented on a single system or on a systems complex, represented by Sysplex A 210 in Region A 202 and Sysplex B 220 in Region B 204. Systems complex (i.e., a sysplex or system) in a mainframe allows authorized components in up to 32 logical partitions (LPARs) to communicate and cooperate with each other using the cross-system coupling facility (XCF) protocol. In mainframes, a cross-system coupling facility (XCF) is a component of z/OS that manages communications between applications in a sysplex or system. Parallel Sysplex® (also referred to as a system) is a cluster of mainframes acting together as a single system image with z/OS. (Parallel Sysplex is a registered trademark of IBM Corporation.). Used for disaster recovery, Parallel Sysplex combines data sharing and parallel computing to allow a cluster of systems to share a workload for high performance and high availability. Geographically Dispersed Parallel Sysplex™ (GDPS®) is an extension of parallel system of mainframes located, potentially, in different cities, Sites or regions. (Geographically Dispersed Parallel Sysplex is a trademark, and GDPS is a registered trademark, of IBM Corporation.) GDPS includes configurations for single region or multiple region configurations. In the event of a failure of a system or storage device, recovery can occur with limited or no data loss automatically.

Furthermore, in FIG. 2, there may be one or more A/A Sites workloads processed by Region A 202 and/or Region B 204. According to one embodiment, the A/A Sites workloads may include OLTP workloads based on a batch job that is processed by Region A 202. Specifically, in an active/standby configuration, the active instances of the workloads may execute on System A 210 of the active Region A 202 and the standby instances of the workloads may be replicated and stored on the standby Region B 204 via Log A 246. For the active Region A 202, the A/A Sites workloads in Region A 202 may include OLTP workloads that may be received from batch job data stored and retrieved from the DB2 database located on server 114. Furthermore, the active Region A 202 may include a copy of processed OLTP workloads (represented by OLTP′, or OLTP prime), which may be stored on DB2 OLTP′ database 234, whereby the copy of the executed OLTP workloads may represent the OLTP workloads that are executed by Sysplex A 212.

Also, for example, in case of a region switch or system failure to Region A 202, the active instances of the workloads may be processed on System B 220 of the Region B 204 and the standby instances of the workloads may be replicated and stored on the Region A 202. For the Region B 204, the A/A Sites workloads in Region B 204 may include OLTP workloads that may be received from batch job data stored on the DB2 database located on server 116, which is software replicated from the DB2 database located on server 114. Furthermore, the now active Region B 204 may include a copy of processed OLTP workloads (represented by OLTP′, or OLTP prime), which may be stored on DB2 OLTP′ database 236, whereby the copy of the processed OLTP workloads may represent the OLTP workloads that have been processed by Sysplex A 212 as well as the OLTP workloads that will be processed by Sysplex B 218 on the System B 220.

Additionally, there may be non-A/A Sites workload data that is executed and stored on Region A 202 and/or Region B 220. Specifically, for Region A 202, the non-A/A Sites workload data may include batch component data that is associated with the batch jobs processed on Region A 202 and/or Region B 204. More specifically, in the A/A Sites continuous availability topology depicted in FIG. 2, the batch component data for Region A 202 may be stored on the Log A 246 which is located on Region B 204. Furthermore, the batch component data for Region B 204 may be stored on the Log B 244 that is located on Region A 202.

According to one embodiment, the batch component data may include a first batch component that may include the transactional target end-state of target objects associated with the OLTP workloads, i.e. the state (such as complete/incomplete, or updated/not updated) of the ultimate target object of the OLTP workload. For Region B 204, a log of the first batch component may be retrieved from Log A 246, which may include batch component data associated with the first batch component from Sysplex A 212, the workload data on the DB2 database located on server 114, and/or the copy of the executed OLTP workload data stored on DB2 OLTP′ database 234. For Region A 202, a log of the first batch component may be retrieved from Log B 244, which may include batch component data associated with the first batch component from Sysplex B 218, the workload data on the DB2 database located on server 116, and/or the copy of the executed OLTP workload data stored on DB2 OLTP′ database 236.

Additionally, the batch component data may include a second batch component that may include the sets of intermediate data files that constitute a working set, or scratchpad data, of a batch job. For example, the working set may include temporary or other files that are used as a transfer mechanism between any two steps associated with the batch job, or more particularly, the OLTP workloads. This data may be typically stored in fast access flat files during processing of a batch job. For Region A 202, the second batch component may be retrieved from the Log B 244, which may include batch component data associated with the second batch component from a database such as VSAM (for the purpose of FIG. 2, but this also can be an IMS or DB2), that is located on Region B 204. For Region B 204, the second batch component may be retrieved from the Log A 246 which may include batch component data associated with the second batch component from a database such as VSAM that is located on Region A 202.

Furthermore, the batch component data may include a third batch component that may include the job scheduler state and plan information, i.e. a collection of schedule data and plan information that enables a batch job to be restarted, from where it left off, after a planned or unplanned outage. The job scheduler state and plan information is typically maintained in physical storage (both in flat files, as referenced above, and more complex storage mechanisms such as VSAM, DB2, or IMS as represented in FIG. 1), and may be used to schedule a batch job as well as to facilitate the transition from one workload to the next workload during processing of the batch job. For Region B 204, the third batch component may be retrieved from the Log A 246, which may include batch component data associated with the third batch component from a database such as IMS (for the purpose of FIG. 2, but this can also be a DB2), that is located on Region A 202. For Region A 202, the third batch component may be retrieved from the Log B 244 that may include batch component data associated with the third batch component from a database, such as IMS, that is located on Region A 202.

There are additional batch components that may come into play, but such batch components are covered by this invention, and its methodology, as well. Examples of other batch components that may be a factor include: job control language (JCL) for a batch job, input files, look-up files, etc. For the sake of simplicity, embodiments of the present invention include the three most commonly-discussed batch components (described above) that are required for synchronization.

As previously described, software replication, such as DB2 Q-replication, may keep the A/A Sites workload's data almost in synch across System A 210 and System B 220. Hardware replication (i.e., disk replication) may mirror all the data (i.e., the A/A Sites workload data and non-A/A Sites workload data) from Region A 202 to Region B 204 for System B 220, and from Region B 204 to Region A 202 for System A 210. However, proxy replication engines 214 and 216 may be used to provide a time consistency between the hardware-replicated batch components and the software-replicated OLTP workloads during a batch job start/restart based on a planned or unplanned region switch. Specifically, and as previously described, the proxy replication engines 214, 216 may read from the secondary logs (Log A 246 and Log B 244) that include the aforementioned batch component data to determine/pinpoint the point-in-time (PIT) at which the OLTP workloads and batch components are stopped during a system failure or region switch for a batch job. The proxy replication engines 214, 216 may also be used to apply the data associated with the batch job up to the determined point-in-time (PIT) at the successor site for the batch job start/restart. Employing read from secondary support, it is guaranteed by the hardware mirroring that all log data to a specific point in time (PIT) has been received and thus can be applied. This log data, at this determined point in time (PIT) snapshot, constitutes a transactional record that is consistent with the related batch components (as previously discussed) that may be maintained in the same disk consistency group on the secondary logs.

As previously described, starting or re-starting a multi-step batch job on its originating site is a fairly less complicated process. While anomalies can result in imprecise restarts, they are rare conditions. In an Active/Active, continuous availability topology, there are two or more sites (Region B 204 and Region A 202) where any given workload can execute at a prescribed time. It is the desire of practitioners of Active/Active to be able to start or restart a multi-step batch job at an alternate site, after the unplanned outage of the primary site. Should the multi-step batch job be in-progress, at the time of the outage, the synchronization of the three batch components (i.e. the first batch component, the second batch component, and the third batch component) is critical for a precise restart, (that is, to restart at the point where the original batch job failed). Synchronization is no less critical, though, for a start of a new batch job at the surviving site, as current processes allow for data conflicts between all of the three batch components and the OLTP workloads.

In the proxy configuration depicted in FIG. 2, however, the three batch components (i.e. the first batch component, the second batch component, and the third batch component) needed for multi-step batch job starts and restarts can be point-in-time (PIT) consistent at the proxy replication engine sites 214, 216 when the disk volumes that hold the DBMS logs (representing the first batch component) and the disk volumes that hold the intermediate files (representing the second batch component) and the disk volumes that hold the job scheduler state (representing the third batch component) are all captured and maintained in the same disk consistency group/set based on the secondary logs (Log A 246 and Log B 244). Specifically, for example, after an outage of the primary (i.e. active) site, such as Region A 202, the proxy engine 216 (reading from secondary Log A 246) holds a point-in-time snapshot of all of the batch components necessary for a batch job start or restart on Region B 204. Additional processing, in the form of software replication of the DBMS instances (i.e. DB2, IMS, VSAM) on Region A 202 to the local DBMS instances on Region B 204, must be completed so as to get the DBMSs in a transactionally consistent state at the time of the primary site failure. Once that is complete, the job scheduler, using the disk replicated job scheduler state and plan information, can restart the batch job from the point-in-time (PIT) of the failure (or even to start a new batch job). The interrupted job can rely on the transactional target end-state of the OLTP workloads and the intermediate data files for input/output from that same point-in-time (PIT).

Thus, according to one embodiment of the present invention, when there is a request for a planned region or workload switch for System A 210, the batch job resynchronization program 108A (using GDPS/A-A scripts) may perform the following: enable the A/A Sites workloads to switch from using the active instances of a workload (i.e., server 114) on System A 210 in Region A 202 to the standby instance of the workloads on System B 220 in Region B 204. The switch may be initiated by an operator by clicking on a “route” button or initiating a region switch script on a GDPS/A-A graphical user interface (GUI). The batch components may provide the capability to restart System A 210 and its associated workload off the secondary mirrored volumes (Log A 246) in Region B 246. The GDPS script capability may be used to provide this capability. The script may be initiated by the operator. The script may stop System A 210 and its associated workload (i.e., server 114) in Region A 202, reverse disk replication from Region A 202 to Region B 204 to Region B 204 to Region A 202, and restart System A 210 and its associated workloads in Region B 204 from the point-in-time (PIT) of the region switch using the proxy replication engine 216. Additionally, when System A 210 is restarted in Region B 204, the former active workload instances of active/standby and/or active/query configurations (i.e., running on server 114) are restarted and become the standby instances of the workloads. Similar processing may take place for a planned or unplanned region switch for System B 220.

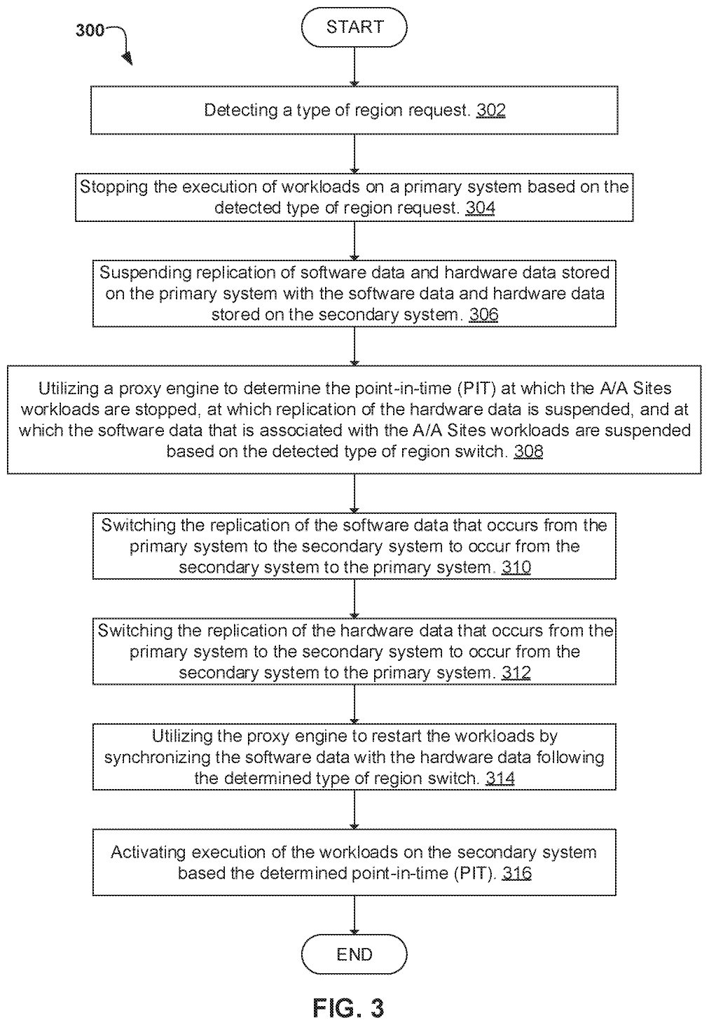

Referring now to FIG. 3, an operational flowchart 300 illustrating the steps of a program for utilizing proxy replication engines 214, 216 (FIG. 2) to synchronize the restart of A/A Sites managed OLTP workloads with batch components following a planned or unplanned region switch operation for System A 210 (i.e., the primary system) is depicted. The region switch use case described in FIG. 3 illustrates an example of the capability to re-synchronize replicated data, i.e. the replicated data based on software data replication (OLTP workloads) with the replicated data based on hardware data replication (batch components), that is managed together by Active/Active Sites, by using proxy replication engines 214, 216 to allow a batch job to be successfully restarted at the recovery region System B 220. Specifically, at 302, the batch job resynchronization program 108A may enable the network computer environment 100 (FIG. 1) to detect a type of region switch request. For example, the type of region switch request may include a planned or unplanned system region. More specifically, the type of region switch requests may include a planned workload switch, a planned region switch, an unplanned workload switch, and an unplanned region switch. For example, the planned region switch request may be initiated by an operator by clicking on a “route” button or initiating a region switch script on a GDPS/A-A GUI, and the unplanned region switch request may be based on a system failure to System A 210. The detected region switch request may initiate a region switch between a primary system (System A 210) and a secondary system (System B 220) for batch job processing.

Then, at 304, in response to the detected region switch request, the batch job resynchronization program 108A may stop all execution of A/A Sites workloads on the primary system, System A 210 (i.e., will not accept new work). For example, all the OLTP transactions (i.e., the workloads) 118 (FIG. 2) coming in to System A 210 (FIG. 2) are tapered off and eventually disabled. After stopping the incoming transactions to System A 210 (FIG. 2), the software replication pipe may be drained. As such, the outstanding transactions are processed. This may be a combination of sending the incoming transactions 118 (FIG. 2) to the workload distributor 112 (FIG. 2) (i.e., the router that sits in front) as well as to a backend database. Therefore, the in-flight transactions are drained in the database systems themselves (i.e., processed) in a managed way.

Furthermore, at 306, and in response to the detected region switch request, the batch job resynchronization program 108A may suspend replication of the software data stored on the primary system (System A 210) to the software data stored on the secondary system (System B 220), and suspend replication of the hardware data stored on the primary system (System A 210) to the hardware data stored on the secondary system (System B 220). With respect to step 306, and as previously described in FIG. 1, the current environment may use software data replication (i.e., software replication) as depicted in FIG. 1 in addition to the utilization of hardware data replication (i.e., disk replication). Specifically, A/A Sites' OLTP workloads are workloads that support OLTP using database management systems (DBMSs) such as the DB2, the IMS, and/or the VSAM (which also have the ability to perform planned and unplanned region switches in seconds). Furthermore, the networked computer environment 100 may include server computers 114 and 116 that are enabled to run DB2 replication, IMS replication, and/or VSAM replication The replicated data based on software data replication (OLTP workloads) and the replicated data based on hardware data replication (batch components) is managed together by the Active/Active Sites of Region A 202 and Region B 204. As such, servers 114 and 116 will replicate with each other to ensure cross-region (or cross-site) workload balancing and continuous availability and disaster recovery. As such, in response to the detected region switch request from System A 210 to System B 220, the batch job resynchronization program 108A may suspend replication of the software data stored on the primary system (System A 210) to the software data stored on the secondary system (System B 220), and suspend replication of the hardware data stored on the primary system (System A 210) to the hardware data stored on the secondary system (System B 220)

Then, at 308, the batch job resynchronization program 108A may utilize one or more proxy engines, such as proxy engine 216, to determine/capture the point-in-time (PIT) at which the A/A Sites workloads are stopped, at which replication of the non-A/A Sites workload data (i.e. hardware data including batch components) that is associated with the A/A Sites workloads is suspended, and at which the A/A Sites workload data (i.e. software data including OLTP workload data) that is associated with the A/A Sites workloads is suspended based on the detected type of region switch. Specifically, and as previously described, the three batch components (i.e. the first batch component, the second batch component, and the third batch component) needed for multi-step batch job starts and restarts can be point-in-time (PIT) consistent at the proxy replication engine 216 when the disk volumes that hold the DBMS logs (representing the first batch component) and the disk volumes that hold the intermediate files (representing the second batch component) and the disk volumes that hold the job scheduler state (representing the third batch component) are all captured and maintained in the same disk consistency group/set on the secondary logs, such as Log A 246. As such, the proxy replication engine 216 may read from the secondary log (Log A 246) located on server 116, to determine/pinpoint the point-in-time (PIT) at which the OLTP workloads and batch components are stopped during the determined type of region switch for the batch job on the primary system (i.e. System A 210). The captured point-in-time (PIT) may represent the status, step, position, and/or the amount of the hardware data and the software data replicated, and the end point-in-time (PIT) of the synchronization between the hardware replicated data and the software replicated data at the time of the stoppage. Therefore, after an outage of the primary system (System A 210), the proxy replication engine 216 (reading from the secondary Log A 246) holds a point-in-time snapshot of all of the batch components necessary for a batch job start or restart for System B 220.

Next, at 310, the batch job resynchronization program 108A may switch the replication of the software data that occurs from the primary system (System A 210) to the secondary system (System B 220) to occur from the secondary system (System B 220) to the primary system (System A 210). Specifically, the A/A Sites workloads are switched from Region A 202 (FIG. 2) to Region B 204 (FIG. 2). For example, there may be an actual switch of the OLTP workloads from server 114 (FIG. 2) in Region A 202 (FIG. 2) to server 116 (FIG. 2) in Region B 204 (FIG. 2). More specifically, for example, the A/A Sites workloads in Region A 202 may include OLTP workloads that may be received from batch job data stored on the DB2 database located on server 114. Furthermore, the active Region A 202 may include a copy of executed OLTP workloads (represented by OLTP′, or OLTP prime), which may be stored on DB2 OLTP′ database 234, whereby the copy of the executed OLTP workloads may represent the OLTP workloads that are executed/processed by Sysplex A 212 on the System A 210. Based on the region switch, the active instances of the workloads may execute on System B 220 of the Region B 204 and the standby instances of the workloads may be replicated and stored on the Region A 202. For the Region B 204, the A/A Sites workloads in Region B 204 may include OLTP workloads that may be received from the batch job data replicated from Region A 202 and stored on the DB2 database located on server 116. Execution of the OLTP workloads may be allowed to continue on System B 220 and a copy of the executed OLTP workloads may then be stored on OLTP′ database 236, and then logged by DB2 Log B 244 on Region A 202.

Then, at 312, the batch job resynchronization program 108A may switch the replication of the hardware data that occurs from the primary system (System A 210) to the secondary system (System B 220) to occur from the secondary system (System B 220) to the primary system (System A 210). Specifically, disk replication associated with the hardware replication is switched from Region A 202 (FIG. 2) to Region B 204 (FIG. 2). Therefore, in the System A 210 (FIG. 2), disk replication is suspended and reversed (i.e., switched) with no copy. Therefore, System A 210 (FIG. 2) is restarted in Region B 204 (FIG. 2). A copy of System A 210 (FIG. 2) in Region B 204 (FIG. 2) (i.e., a batch copy of System A 210 (FIG. 2) in Region B 204 (FIG. 2)) may now be allowed to start.

Next, at 314, the batch job resynchronization program 108A may utilize the proxy engine 216 to restart the A/A Sites workloads by synchronizing the A/A Sites workload data (i.e. the software data including the OLTP workloads data) with the non A/A Sites workload data (i.e. the hardware data including the batch components) following the determined type of region switch. Specifically, and as previously described with respect to the proxy configuration depicted in FIG. 2, the three batch components needed for multi-step batch job restarts may be point-in-time (PIT) consistent at the proxy engine 216. Therefore, after an outage of the primary system (System A 210), the proxy replication engine 216 (reading from the secondary Log A 246) holds a point-in-time snapshot of all of the batch components necessary for a batch job start or restart on System B 220. As previously described, this log data, at this point in time (PIT) snapshot, constitutes a transactional record (of OLTP workloads) that is consistent with the related batch components (the three batch components as previously discussed). Furthermore, and as previously discussed, software replication of the DBMS instances (i.e. DB2, IMS, VSAM) on Region A 202 to the local DBMS instances on Region B 204 must be completed so as to get the DBMS instances in a transactional consistent state as of the time of the detected region switch. Once that is complete, the batch job resynchronization program 108A may enable the job scheduler, using the disk replicated job scheduler state and plan information, to restart the batch job on the System B 220 from the point-in-time (PIT) of the determined type of region switch. The batch job resynchronization program 108A may rely on the transactional target end-state of the OLTP workloads and the intermediate data files for input/output from that same point-in-time (PIT).

Then, at 316, the batch job resynchronization program 108A may activate execution of the A/A Sites workloads on the secondary system (System B 220) based the determined point-in-time (PIT) of the A/A Sites workloads, the switching of the replication of both the hardware data and the software data, and on the synchronization of the software data and the hardware data up to the determined point-in-time (PIT) associated with the at least one proxy engine and the plurality of batch components.

It may be appreciated that FIGS. 1-3 provide only illustrations of one implementation and does not imply any limitations with regard to how different embodiments may be implemented. Many modifications to the depicted environments may be made based on design and implementation requirements.

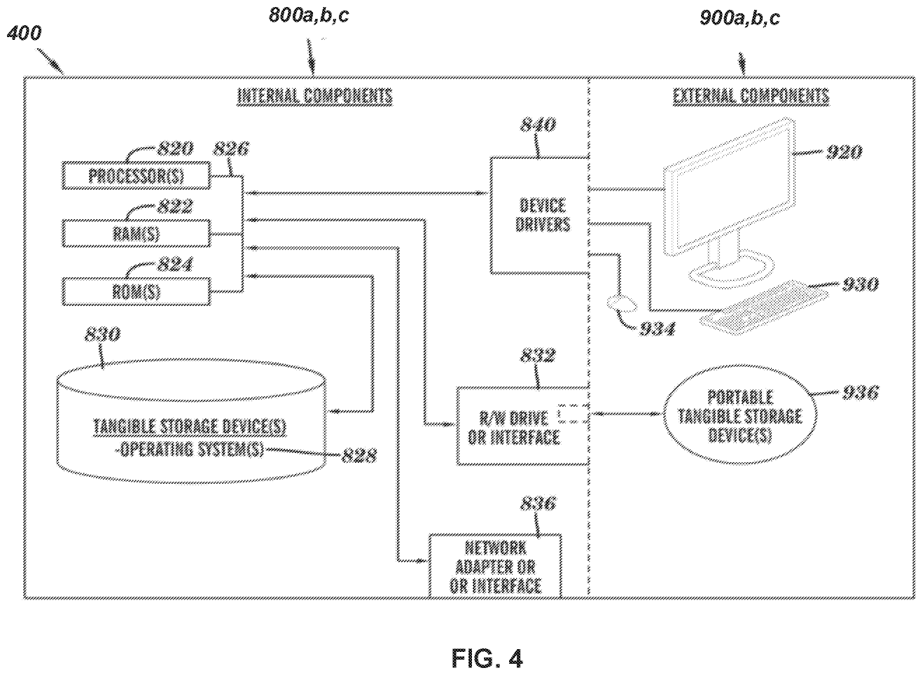

FIG. 4 is a block diagram of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Workload balancing program 300 may be implemented on an electronic device such as user client computer 102 (FIG. 1) and network server computers 114 and 116 (FIG. 1). User client computer 102 (FIG. 1), and network server computers 114 (FIG. 1) may include respective sets of internal components 800 a, b, c and external components 900 a, b, c illustrated in FIG. 4. Each of the sets of internal components 800 a, b, c includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and software program 108 (FIG. 1) in client computer 102 are stored on one or more of the respective computer-readable tangible storage devices 830 for execution by one or more of the respective processors 820 via one or more of the respective RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a, b, c also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program 108 can be stored on one or more of the respective portable computer-readable tangible storage devices 936, read via the respective R/W drive or interface 832 and loaded into the respective hard drive 830.

Each set of internal components 800 a, b, c also includes network adapters or interfaces 836 such as a TCP/IP adapter cards, wireless wi-fi interface cards, or 3G or 4G wireless interface cards or other wired or wireless communication links. A software program 108 in client computer 102 can be downloaded to client computer 102 from an external computer via a network (for example, the Internet, a local area network or other, wide area network) and respective network adapters or interfaces 836. From the network adapters or interfaces 836, the software program 108 in client computer 102 is loaded into the respective hard drive 830. The network may comprise copper wires, optical fibers, wireless transmission, routers, firewalls, switches, gateway computers and/or edge servers.

Each of the sets of external components 900 a, b, c can include a computer display monitor 920, a keyboard 930, and a computer mouse 934. External components 900 a, b, c can also include touch screens, virtual keyboards, touch pads, pointing devices, and other human interface devices. Each of the sets of internal components 800 a, b, c also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown). The one or more operating systems 828, the software program 106 (FIG. 1) and the batch job resynchronization program 108A (FIG. 1) in client computer 102 (FIG. 1) (and the batch job resynchronization program 108A (FIG. 1) that may also be network server computers 114, 116 (FIG. 1) are stored on one or more of the respective computer-readable tangible storage devices 830 for execution by one or more of the respective processors 820 via one or more of the respective RAMs 822 (which typically include cache memory).

The batch job resynchronization program 108A (FIG. 1) and software program 106 (FIG. 1) in client computer 102 (FIG. 1) can be downloaded from an external computer via a network (for example, the Internet, a local area network or other, wide area network) and respective network adapters or interfaces 836. From the network adapters or interfaces 836, the batch job resynchronization program 108A (FIG. 1) and software program 106 (FIG. 1) in client computer 102 (FIG. 1) may be loaded into the respective hard drive 830. The network may comprise copper wires, optical fibers, wireless transmission, routers, firewalls, switches, gateway computers, and/or edge servers.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

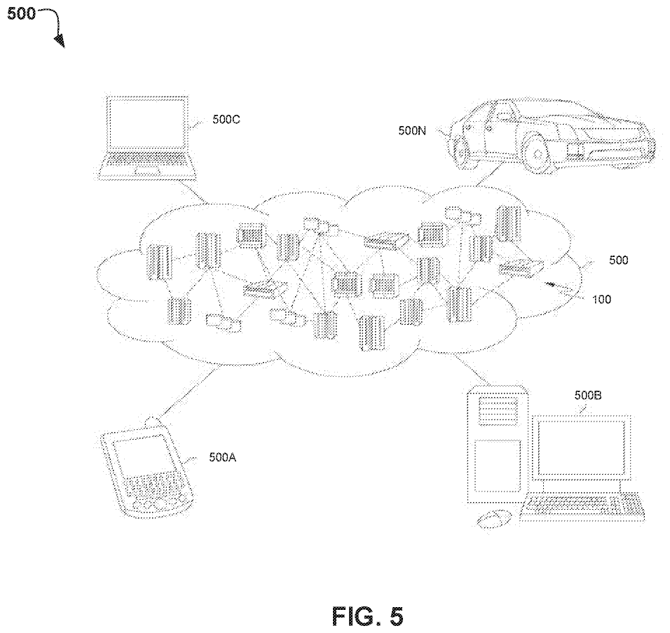

Referring now to FIG. 5, illustrative cloud computing environment 500 is depicted. As shown, cloud computing environment 500 comprises one or more cloud computing nodes 100 with which local computing devices used by cloud consumers, such as, for example, personal digital assistant (PDA) or cellular telephone 500A, desktop computer 500B, laptop computer 500C, and/or automobile computer system 500N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 500A-N shown in FIG. 5 are intended to be illustrative only and that computing nodes 100 and cloud computing environment 500 can communicate with any type of computerized device over any type of network and/or network addressable connection (e.g., using a web browser).

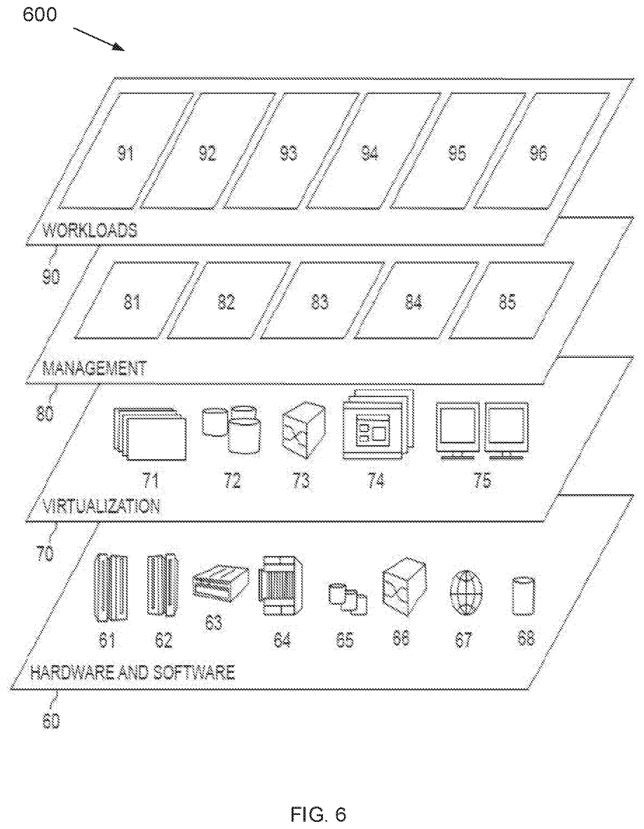

Referring now to FIG. 6, a set of functional abstraction layers 600 provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and batch job resynchronization 96. A batch job resynchronization program 108A, 108B (FIG. 1) may be offered “as a service in the cloud” (i.e., Software as a Service (SaaS)) for applications running on computing devices 102 (FIG. 1) and may utilize proxy replication engines to synchronize, at a point-in-time (PIT) consistency, the restart of A/A Sites managed OLTP workloads and batch components that are associated with a batch job.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for resynchronizing at least one batch job comprising a plurality of workloads executing on both a primary system and a secondary system by using at least one proxy replication engine, the method comprising:
detecting a type of region switch request;
in response to the detected type of region switch request, stopping execution of the plurality of workloads on the primary system;
in response to stopping execution of the plurality of workloads, suspending a replication of software data stored on the primary system with a copy of the software data stored on the secondary system, and suspending a replication of hardware data stored on the primary system with a copy of the hardware data stored on the secondary system;
utilizing the at least one proxy replication engine to determine a point-in-time (PIT) at which the execution of the plurality of workloads on the primary system is stopped, at which the replication of the software data is suspended, and at which the replication of the hardware data is suspended, wherein utilizing the at least one proxy replication engine comprises using the at least one proxy replication engine to read from at least one secondary log the hardware data comprising a plurality of batch components associated with the plurality of workloads and the point-in-time (PIT);
switching the replication of the software data that occurs from the primary system to the secondary system to occur from the secondary system to the primary system;
switching the replication of the hardware data that occurs from the primary system to the secondary system to occur from the secondary system to the primary system;
synchronizing the software data and the hardware data for the plurality of workloads up to the determined point-in-time (PIT) and based on the point-in-time (PIT) associated with the plurality of batch components; and
activating the execution of the plurality of workloads on the secondary system based on the determined point-in-time (PIT), the switching of the replication of both the hardware data and the software data, and the synchronization of the software data and the hardware data up to the determined point-in-time (PIT) associated with the at least one proxy engine and the plurality of batch components.

2. The computer-implemented method of claim 1, wherein the software data comprises Active/Active Sites workload data on both the primary system and the secondary system, and wherein the primary system is located at a first region and the secondary system is located at a second region.

3. The computer-implemented method of claim 1, wherein the plurality of batch components comprises a first batch component, a second batch component, and a third batch component.

4. The computer-implemented method of claim 3, wherein the first batch component comprises a transactional target end-state of one or more target objects associated with the plurality of workloads.

5. The computer-implemented method of claim 3, wherein the second batch component comprises one or more sets of intermediated data files that include a working set of batch job data associated with the at least one batch job.

6. The computer-implemented method of claim 3, wherein the third batch component comprises job scheduler state and plan information, and wherein the job scheduler state and plan information comprises schedule and plan data that enables the at least one batch job to be restarted based on the detected type of region request.

7. The computer-implemented method of claim 3, wherein synchronizing the software data and the hardware data for the plurality of workloads further comprises:
synchronizing the software data, the first batch component, the second batch component, and the third batch component.

8. A computer system for resynchronizing at least one batch job comprising a plurality of workloads executing on both a primary system and a secondary system by using at least one proxy replication engine, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
detecting a type of region switch request;
in response to the detected type of region switch request, stopping execution of the plurality of workloads on the primary system;
in response to stopping execution of the plurality of workloads, suspending a replication of software data stored on the primary system with a copy of the software data stored on the secondary system, and suspending a replication of hardware data stored on the primary system with a copy of the hardware data stored on the secondary system;
utilizing the at least one proxy replication engine to determine a point-in-time (PIT) at which the execution of the plurality of workloads on the primary system is stopped, at which the replication of the software data is suspended, and at which the replication of the hardware data is suspended, wherein utilizing the at least one proxy replication engine comprises using the at least one proxy replication engine to read from at least one secondary log the hardware data comprising a plurality of batch components associated with the plurality of workloads and the point-in-time (PIT);
switching the replication of the software data that occurs from the primary system to the secondary system to occur from the secondary system to the primary system;
switching the replication of the hardware data that occurs from the primary system to the secondary system to occur from the secondary system to the primary system;
synchronizing the software data and the hardware data for the plurality of workloads up to the determined point-in-time (PIT) and based on the point-in-time (PIT) associated with the plurality of batch components; and
activating the execution of the plurality of workloads on the secondary system based on the determined point-in-time (PIT), the switching of the replication of both the hardware data and the software data, and the synchronization of the software data and the hardware data up to the determined point-in-time (PIT) associated with the at least one proxy engine and the plurality of batch components.

9. The computer system of claim 8, wherein the software data comprises Active/Active Sites workload data on both the primary system and the secondary system, and wherein the primary system is located at a first region and the secondary system is located at a second region.

10. The computer system of claim 8, wherein the plurality of batch components comprises a first batch component, a second batch component, and a third batch component.

11. The computer system of claim 10, wherein the first batch component comprises a transactional target end-state of one or more target objects associated with the plurality of workloads.

12. The computer system of claim 10, wherein the second batch component comprises one or more sets of intermediated data files that include a working set of batch job data associated with the at least one batch job.

13. The computer system of claim 10, wherein the third batch component comprises job scheduler state and plan information, and wherein the job scheduler state and plan information comprises schedule and plan data that enables the at least one batch job to be restarted based on the detected type of region request.

14. The computer system of claim 10, wherein synchronizing the software data and the hardware data for the plurality of workloads further comprises:
synchronizing the software data, the first batch component, the second batch component, and the third batch component.

15. A computer program product for resynchronizing at least one batch job comprising a plurality of workloads executing on both a primary system and a secondary system by using at least one proxy replication engine, comprising:
one or more computer-readable storage devices and program instructions stored on at least one of the one or more tangible storage devices, the program instructions executable by a processor, the program instructions comprising:
program instructions to detect a type of region switch request;
in response to the detected type of region switch request, program instructions to stop execution of the plurality of workloads on the primary system;
in response to stopping execution of the plurality of workloads, program instructions to suspend a replication of software data stored on the primary system with a copy of the software data stored on the secondary system, and suspending a replication of a hardware data stored on the primary system with a copy of the hardware data stored on the secondary system;
program instructions to utilize the at least one proxy replication engine to determine a point-in-time (PIT) at which the execution of the plurality of workloads on the primary system is stopped, at which the replication of the software data is suspended, and at which the replication of the hardware data is suspended, wherein utilizing the at least one proxy replication engine comprises using the at least one proxy replication engine to read from at least one secondary log the hardware data comprising a plurality of batch components associated with the plurality of workloads and the point-in-time (PIT);
program instructions to switch the replication of the software data that occurs from the primary system to the secondary system to occur from the secondary system to the primary system;
program instructions to switch the replication of the hardware data that occurs from the primary system to the secondary system to occur from the secondary system to the primary system;
program instructions to synchronize the software data and the hardware data for the plurality of workloads up to the determined point-in-time (PIT) and based on the point-in-time (PIT) associated with the plurality of batch components; and
program instructions to activate the execution of the plurality of workloads on the secondary system based on the determined point-in-time (PIT), the switching of the replication of both the hardware data and the software data, and the synchronization of the software data and the hardware data up to the determined point-in-time (PIT) associated with the at least one proxy engine and the plurality of batch components.

16. The computer program product of claim 15, wherein the plurality of batch components comprises a first batch component, a second batch component, and a third batch component.

17. The computer program product of claim 16, wherein the first batch component comprises a transactional target end-state of one or more target objects associated with the plurality of workloads.

18. The computer program product of claim 16, wherein the second batch component comprises one or more sets of intermediated data files that include a working set of batch job data associated with the at least one batch job.

19. The computer program product of claim 16, wherein the third batch component comprises job scheduler state and plan information, and wherein the job scheduler state and plan information comprises schedule and plan data that enables the at least one batch job to be restarted based on the detected type of region request.

20. The computer program product of claim 16, wherein the program instructions to synchronize the software data and the hardware data for the plurality of workloads further comprises:
program instructions to synchronize the software data, the first batch component, the second batch component, and the third batch component.
